(19) United States
(12) Patent Application Publication
(10) Pub. No.: US 2004/0242247 A1
(43) Pub. Date: Dec. 2, 2004

(54) Automatic short message service notification of powered up mobile phone

(76) Inventors: David S. Benco, Winfield, IL (US); Kevin J. Overend, Elmhurst, IL (US); Baoling S. Sheen, Naperville, IL (US); Sandra T. True, St. Charles, IL (US); Kenneth J. Voight, Sugar Grove, IL (US)

Correspondence Address: PATTI & BRILL, ONE NORTH LASALLE STREET, 44TH FLOOR, CHICAGO, IL, 60602, US

(21) Appl. No.: 10/452,354

(22) Filed: Jun. 2, 2003

(51) Int. Cl. H04Q 7/20

(52) U.S. Cl. 455/466; 455/461

(57) ABSTRACT

A method and system provides for automatically notifying at least one of unanswered callers and a personal chat group that a mobile phone is ready to accept calls. In one embodiment the method may have the steps of: creating, for a first mobile phone, at least one of a first SMS message to be sent for unanswered calls, the unanswered calls occurring when the first mobile phone is powered down, and a second SMS message to be sent to a personal chat group, and an SMS message to be sent to a personal chat group; and automatically sending, when the first mobile phone is powered up, the created SMS messages to at least one of further second mobile phones associated with the unanswered calls and further third mobile phones associated with the personal chat group. The system implements the method.

### TECHNICAL FIELD

The present invention relates to wireless telephony in general, and, more particularly, to embodiments of a method and system for providing an automatic procedure for notifying callers that the mobile phone is powered up again and ready to receive calls. Further embodiments of the method and apparatus send predetermined SMS messages to other mobile users at certain times/dates.

### BACKGROUND OF THE INVENTION

Wireless devices and telephones, which include both cellular telephones and the higher frequency personal communication devices (PCDs), are growing in numbers and also shrinking in size and weight. The growth in numbers is influenced by the convenience and the per call cost of wireless telephones with respect to pagers and wire line telephones or coin telephones for completing calls, especially when the user is away from home or office. The shrinking size is influenced by two related technologies: more efficient receive/transmit processing circuits and higher power density batteries.

The Short Message Service (SMS) is a point-to-point or point-to-multipoint service, which enables a user to send messages to and receive text messages from other users of a communications network. The SMS attempts to deliver a message to a mobile terminal or phone whenever the terminal is registered to the network, even when the terminal is engaged in a voice or data call. The terminal may also roam throughout the network and still be capable of sending and receiving messages. A terminal configured for SMS provides methods for the user to receive, read, write/edit, clear, send, and save messages.

The network stores messages in at least one Message Center (MC), and Mobile Terminated (MT) messages are sent to the terminal by the MC. Various SMS protocol layers receive the messages and check their contents. If the contents are valid, and assuming that there is room for incoming text messages in the memory of the terminal, the message is received and stored. Otherwise, the message is rejected. Systems are known in which a paging system enables messages to be sent to a remote unit, and which has a capability for the remote unit to transmit a message-received acknowledgement signal back to a central site. This paging system also enables a message-presented verification to be transmitted from an addressed pager back to the central site.

In order to extend mobile battery life, avoid interruptions or for many other reasons, mobile phone users frequently turn off their mobile phones. Although callers to a mobile phone that is powered down sometimes leave a voice message, often a caller would like to know exactly when to call back with a good chance of getting an answer. Also, prior art systems do not allow for future delivery scheduling of SMS messages.

Therefore, there is a need in the art for an improved system and method for providing an automatic procedure for notifying callers that the mobile phone is powered up again and ready to receive calls, as well as, for a method and system that allows for future delivery scheduling of SMS messages.

### SUMMARY

The following summary of embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of an embodiment of the present method and system to provide a method and system for automatically notifying at least one of unanswered callers and a personal chat group that a mobile phone is ready to accept calls.

In one embodiment the method may have the steps of: creating, for a first mobile phone, at least one of a first SMS message to be sent for unanswered calls, the unanswered calls occurring when the first mobile phone is powered down, and a second SMS message to be sent to a personal chat group; and automatically sending, when the first mobile phone is powered up, the created SMS messages to at least one of further second mobile phones associated with the unanswered calls and further third mobile phones associated with the personal chat group.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrative of a mobile switching center, base station and mobile station for use with the present method and system.

FIG. 2 illustrates a more detailed block diagram illustrative of a mobile switching center, base station, and mobile station according to one embodiment of the present method and system.

FIG. 3 illustrates a very general flow chart of logical operational steps that may be followed in accordance with one embodiment of the present method and system.

FIG. 4 illustrates another flow chart of logical operational steps that may be followed in accordance with one embodiment of the present method and system.

FIG. 5 illustrates yet a further flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

Wireless communication systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features that the manufacturer offers to the service provider and which the service provider offers to the consumer are similar between the different wireless systems.

Regardless of the modulation scheme in use, the wireless phone (mobile terminal or phone) available to the end user may have a number of different features implemented. Nearly all wireless phones incorporate a display that allows the user to enter text banners, display dialed numbers, and display incoming caller numbers. Additionally, wireless phones may incorporate electronic phonebooks, speed dialing, single button voicemail access, and messaging capabilities.

Of course, in order for the consumer to take full advantage of all the features implemented in the phone many of the features require complementary feature support from the service provider. Voicemail storage and messaging capabilities necessarily must be implemented by the service provider in order for the consumer to have access through their supporting phones.

Additionally, features that are not apparent to the user may be incorporated into phones and capable of service provider support. Any individual feature is capable of implementation into some or all of the wireless systems using the modulation schemes mentioned above. A particularly useful feature provides messaging capability within phones. The Short Message Services (SMS) feature used in a CDMA wireless communication system allows for information transfer to and from a wireless phone. However, the implementation of SMS is not limited to use in a CDMA system. Short Message Services (SMS) are used to allow the communication of alphanumeric messages to wireless phones.

In a CDMA wireless communication system information is carried over multiple channels on a carrier frequency distinguished by modulation using orthogonal codes. The forward link (base station to subscriber unit) and the reverse link (subscriber unit to base station) use different carrier frequencies. The distinct orthogonal codes define channels for communication of information. Aside from the Pilot and Sync channels, there may be multiples of each channel type within the coverage area of any particular base station. Each channel will be distinguished by a separate orthogonal code such that simultaneous communication over the same frequency space is possible.

The subscriber unit, or mobile terminal, uses the Pilot and Sync channel transmissions by each base station to acquire and synchronize to the CDMA system. The Pilot and Sync channels contain system overhead information only and the subscriber unit does not transmit on these channels. The subscriber unit utilizes the Pilot and Sync channels to align the internal timing of the subscriber unit with the timing of the base station.

One or more Paging channels may exist in the system. Once the subscriber unit has acquired the Pilot and Sync channels, it monitors the Paging channel for messages directed to it. The messages may include overhead messages relating to link parameters or may include directed messages for a particular subscriber unit. The Paging channel is also used to transmit acknowledgements or responses to messages generated by the subscriber unit. The communication on the Paging channel can be directed from the base station to an individual subscriber unit, as in the case of an acknowledgement message, or can be directed from the base station to many subscriber units simultaneously, as in the case of broadcast messages.

The complement to the Paging channel is the Access channel. The base station monitors the Access channel for messages generated by the subscriber unit. The subscriber unit can transmit a variety of messages to the base station on the Access channel. The messages may include data burst messages, acknowledgements or responses to received paging messages, and registration access messages.

The Traffic channel completes the list of channel types available in a CDMA wireless communication system. The Traffic channel is used for voice, data, and messages. When communication is assigned to a Traffic channel both a forward link channel, enabling communication from the base station to the subscriber unit, and the reverse link channel, enabling communication from the subscriber unit to the base station, are dedicated to the current communication.

Thus, the SMS feature allows the communication of short alphanumeric messages between the base station and the subscriber unit. Messages may be initiated at a message center and transmitted via the base station to the subscriber unit. Messages may also be initiated at the subscriber unit and transmitted to the message center through the base station.

Messages transmitted from the base station to the subscriber unit may be transmitted over the Paging or Traffic channels. The messages transmitted to the subscriber unit are formatted as Data Burst Messages. Messages may either be directed to individual subscriber units as point-to-point messages or may be simultaneously directed to many subscriber units as broadcast messages. Even when broadcast messages are sent there is still the ability to provide some subscriber unit differentiation. The ability to direct broadcast messages to particular groups of subscriber units may be provided in broadcast addresses. Subscriber units process a broadcast message only if it has been configured to accept the broadcast address. If the subscriber unit has not been configured to accept the broadcast address, the message will be discarded and not processed.

In general terms the present system and method is for automatically notifying at least one of unanswered callers and a personal chat group that a mobile phone is ready to accept calls. In one embodiment the method has the steps of: creating, for a first mobile phone, at least one of a first SMS message to be sent for unanswered calls when the first mobile phone is powered down, and a second SMS message to be sent to a personal chat group, and an SMS message to be sent to a personal chat group; and automatically sending, when the first mobile phone is powered up, the created SMS messages to at least one of further second mobile phones associated with the unanswered calls and further third mobile phones associated with the personal chat group.

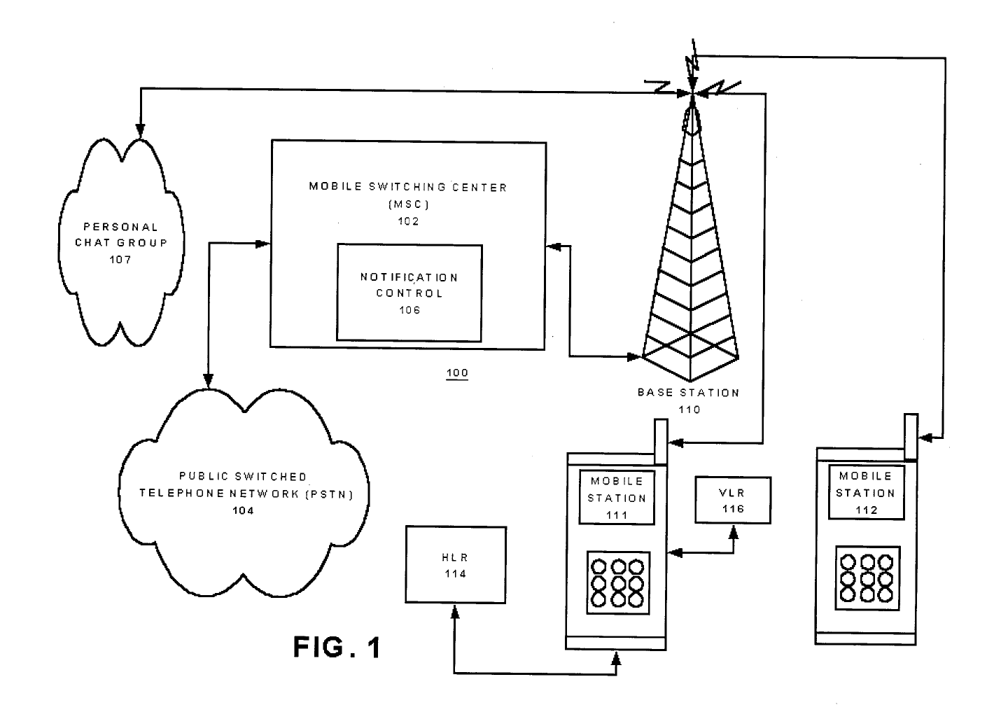

Referring to FIG. 1, a system 100 is depicted for implementing automatic notification of at least one of unanswered callers and a personal chat group that a mobile phone is ready to accept calls. The mobile phone may also be referred to as a mobile unit, a mobile station, a wireless station, a wireless device, or a cell phone. Communication network or system 100 may have a mobile switching center (MSC) 102. The system may be, or may be part of, one or more of a telephone network, a local area network (“LAN”), the Internet, and a wireless network. In the depicted embodiment, a public switched telephone network (PSTN) 104 is connected to MSC 102. The PSTN 104 routes calls to and from mobile users through the MSC 102. The MSC 102 is also connected to one or more base stations (BS) 110. Each of the base stations 110 communicates with mobile station(s) 111, 112 in its service area, as well as, mobile stations and other communication devices in a personal chat group 107. The PSTN 104 generally can be implemented as the worldwide voice telephone network accessible to all those with telephones and access privileges (e.g., AT&T long distance network).

Each of the mobile stations, such as mobile station 111, has a home location register (HLR) 114 where data about each of the mobile stations resides. Some of the mobile stations may be remotely located from their home location, and in that case, a visiting location register (VLR) 116 is set up locally for each mobile station that is visiting in its service area. HLR 114 can be implemented as a permanent SS7 database utilized in cellular networks, such as, but not limited to, for example, AMPS (Advanced Mobile Phone System), GSM (Global System for Mobile Communications), and PCS.

HLR 114 can be utilized generally to identify/verify a subscriber, and also contains subscriber data related to features and services. HLR 114 is generally utilized not only when a call is being made within a coverage area supported by a cellular provider of record, but also to verify the legitimacy and to support subscriber features when a subscriber is away from his or her home area. VLR 116, on the other hand, can be implemented as a local database maintained by the cellular provider whose territory is being roamed. Mobile stations may be implemented as a cellular device, personal communication device, short message service device or wireless communications device (e.g., a wireless personal digital assistant).

The MCS 102 may have, or be operatively connected to, a notification control module 106 as will be described below.

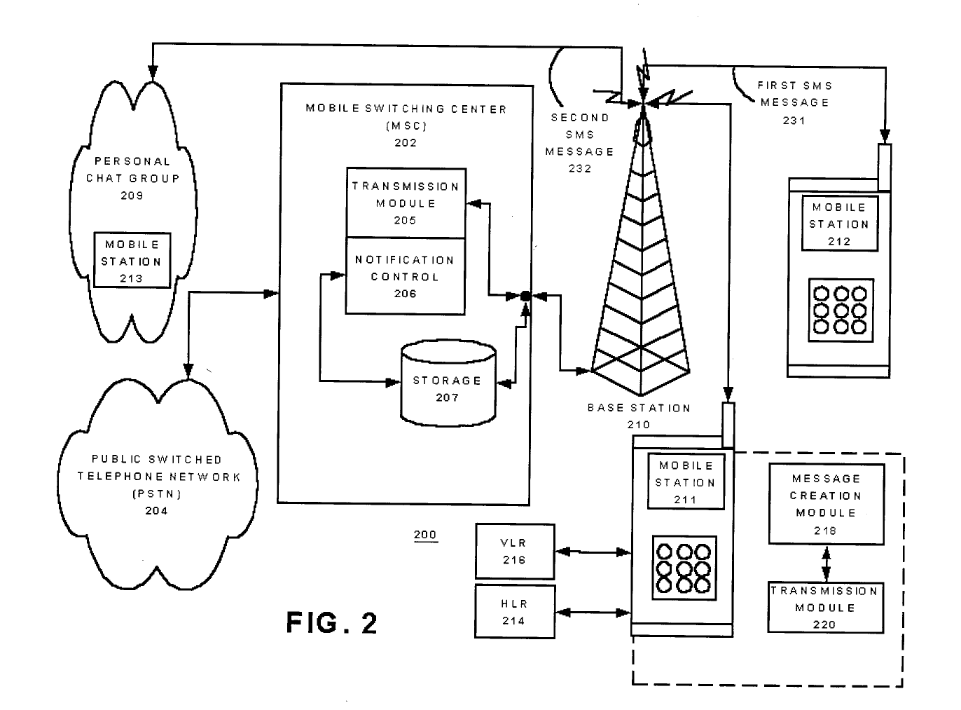

Referring to FIG. 2, a communication network or system 200 is shown in a more detailed block diagram. FIG. 2 shows a mobile switching center 202 operatively connected to a PSTN 204, base station 210, mobile stations 211, 212 and personal chat group 209 according to one embodiment of the present method and system. The base station 210 communicates through the air to mobile stations 211, 212, which may be, for example, of a cellular telephone type or of the wider bandwidth personal communication device type. Mobile stations 212 may in general be any type of battery powered communication device. The base station 210 communicates through the air to the personal chat group 209.

The mobile switching center 202 may have a transmission module 205 operatively connected to a storage 207. The mobile station 211 may have a message creation module 218, and a transmission module 220.

The system 200 is in general for automatically notifying at least one of unanswered callers and a personal chat group that a mobile phone is ready to accept calls. The first mobile station or phone 211 has a message creation module 218 that allows a user of the first mobile phone 211 to create at least one of a first SMS message 231 to be sent for unanswered calls, the unanswered calls occurring when the first mobile phone 211 is powered down, and a second SMS message 232 to be sent to a personal chat group 209. At least one transmission module 220 in the first mobile phone 211 effects sending the created SMS messages to the network for storage in storage 207. The notification module 206 effects automatic sending, when the first mobile phone 211 is powered up, of the stored SMS messages 231 and 232 to a second mobile phone 212 associated with an unanswered call and to a third mobile phone 213 associated with the personal chat group 209. In other embodiments, there may be a plurality of SMS messages, second mobile phones and third mobile phones.

The first SMS message 231 may be transferred from the mobile station 211 to the mobile switching center 202 by the transmission module 220 in the first mobile station 211. The first SMS message 231 is then stored in storage 207 in the mobile switching center 202 of the telecommunications network 200. Upon power up of the mobile station 211, the user-defined first SMS messages 231 are automatically sent from the telecommunications center 200 to each unanswered caller since the first mobile station 211 was most recently powered down. Thus this is a network-based feature.

The second SMS message 232 may be transferred from the mobile station 211 to the mobile switching center 202 by the transmission module 220 in the first mobile station 211. The second SMS message 232 is then stored in storage 207 in the mobile switching center 202 of the telecommunications network 200. Upon power up of the mobile station 211, the user-defined second SMS messages 232 are automatically sent to each caller in the personal chat group 209. Thus this is also a network-based feature, since the chat group members are also stored in storage 207 in the mobile switching center 202 of the telecommunications network 200.

The notification module 206 in conjunction with the transmission module 205 in the MSC 202 effects automatic sending, when the future time occurs, of the future SMS message to the second mobile phone. The message creation module 218 creates the future SMS message, which is stored in the storage 207 in the mobile switching center 202 of the telecommunications network 200. The identity of the second mobile station is also stored in the storage 207 in the mobile switching center 202 of the telecommunications network 200. This is a network-based feature, since the message text and the sending time/date are both stored in the telecommunications network.

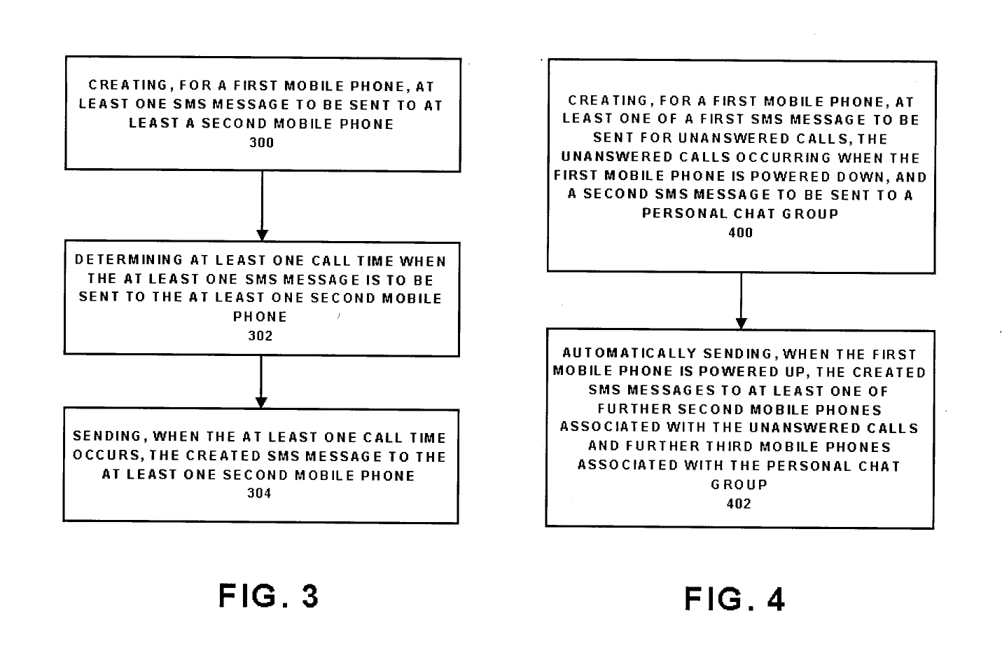

One embodiment of the method for providing notification that a mobile phone is ready to accept calls is depicted in very general terms in FIG. 3. This embodiment of the present method has the steps of: creating, for a first mobile phone, at least one SMS message to be sent to at least a second mobile phone (step 300); determining at least one call time when the at least one SMS message is to be sent to the at least one second mobile phone (step 302); and sending, when the at least one call time occurs, the created SMS message to the at least one second mobile phone (step 304).

An example of creating a SMS message is described as follows.

SMS messages are created by menu navigation at the mobile phone. Mobile subscribers are prompted to enter the message text and then prompted for the destination mobile number or broadcast address (identification of mobile phone). Known SMS messages require an additional field, namely, one of: a date/time, “no-answer”, or “chat-group”, to respectively indicate that the SMS message should be delivered at the prescribed date/time, that the SMS message should be delivered to all callers whose calls were unanswered since the mobile was powered down, and that the SMS message should be delivered to all members of a personal chat group. This requires both mobile and network involvement, since the menus on the mobile phone must change to prompt for the additional field, and the network must recognize the new classes of SMS messages and store and deliver them appropriately.

In FIG. 4 another embodiment of the present method is depicted. In this embodiment the method automatically notifies at least one of unanswered callers and a personal chat group that a mobile phone is ready to accept calls. This embodiment of the present method has the steps of: creating, for a first mobile phone, at least one of a first SMS message to be sent for unanswered calls, the unanswered calls occurring when the first mobile phone is powered down, and a second SMS message to be sent to a personal chat group (step 400); and automatically sending, when the first mobile phone is powered up, the created SMS messages to at least one of further second mobile phones associated with the unanswered calls and further third mobile phones associated with the personal chat group (step 402).

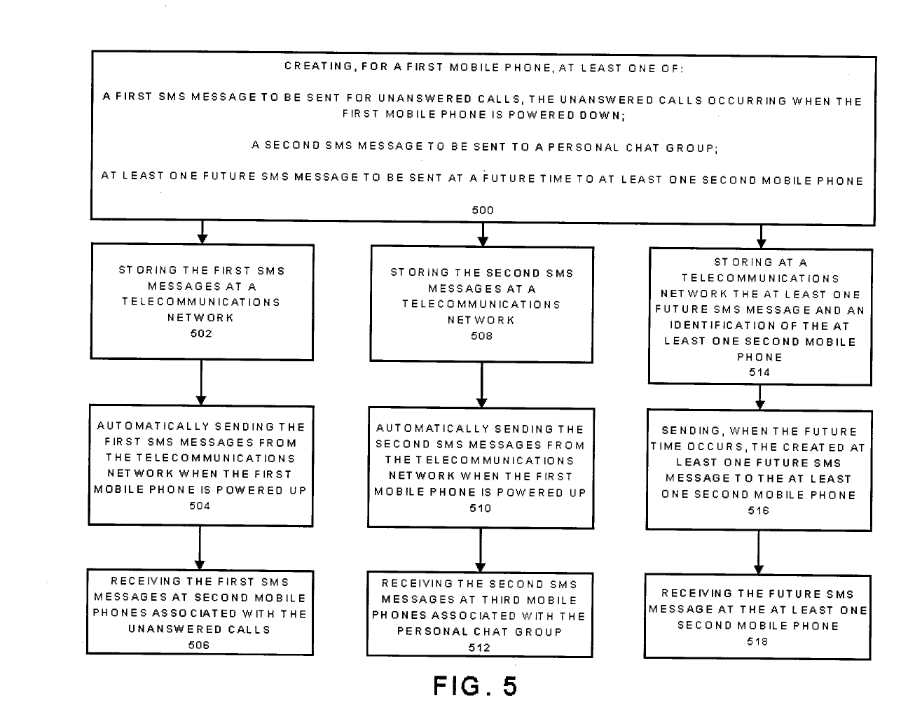

A more detailed flowchart is depicted in FIG. 5, wherein a first step 500, includes creating, for a first mobile phone, at least one of: a first SMS message to be sent for unanswered calls, the unanswered calls occurring when the first mobile phone is powered down; a second SMS message to be sent to a personal chat group; and at least one future SMS message to be sent at a future time to at least one second mobile phone.

In step 502, the first SMS messages are stored at a telecommunications network. In step 504, the first SMS messages are automatically sent from the telecommunications network when the first mobile phone is powered up. The first SMS messages are received at second mobile phones that are associated with the unanswered calls (step 506).

A personal chat group is a (inventors, please define “personal chat group”). In step 508, the second SMS messages are stored at a telecommunications network. In step 510, the second SMS messages are automatically sent from the network to third mobile phones in the personal chat group when the first mobile phone is powered up. In step 512, the second SMS messages are received at the third mobile phones associated with the personal chat group.

In a further embodiment of the present method, the network may be programmed to send a predetermined SMS message to a given number of mobile phones at a specified future time/date. In step 514, at least one future SMS message is stored at a telecommunications network along with identification of at least one second mobile phone. In step 516, the created at least one future SMS message is sent, when the future time occurs, to the at least one second mobile phone. The at least one future SMS message is then received at the at least one second mobile phone (step 518). Thus, the network is able to send predetermined SMS messages to other mobile phones at a future time/date.

Therefore, the present method and system overcomes the drawbacks in the prior art by providing an improved system and method for automatic notification of callers that the mobile phone is powered up again and ready to receive calls, as well as, for a method and system that allows for future delivery scheduling of SMS messages.

The present system and method may be used with non-mobile phones, as well as, mobile phones. Also, different types of data storage devices may be used with the present method and system. For example, a data storage device may be one or more of a magnetic, electrical, optical, biological, and atomic data storage medium. The present invention overcomes the drawbacks of the prior art and provides an improved method and system in a telecommunications network for providing notification that a mobile phone is ready to accept calls.

The method and system of the present invention may be implemented in hardware, software, or combinations of hardware and software. In a software embodiment, portions of the present invention may be computer program products embedded in computer readable medium. Portions of the system may employ and/or comprise a set and/or series of computer instructions written in or implemented with any of a number of programming languages, as will be appreciated by those skilled in the art.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

We claim:

1. A method for providing notification that a mobile phone is ready to accept calls, said method comprising the steps of:
creating, for a first mobile phone, at least one SMS message to be sent to at least a second mobile phone;
determining at least one call time when the at least one SMS message is to be sent to the at least one second mobile phone; and
sending, when the at least one call time occurs, the created SMS message to the at least one second mobile phone.

2. The method of claim 1 wherein the method further comprises in the step of creating; creating, for the first mobile phone, at least one of a first SMS message to be sent for unanswered calls, the unanswered calls occurring when the first mobile phone is powered down, and a second SMS message to be sent to a personal chat group.

3. The method of claim 2 wherein the at least one call time is a time when the first mobile phone is powered up from a powered down condition; and wherein the method further comprises in the step of sending; automatically sending, when the first mobile phone is powered up, the created SMS messages to at least one of further second mobile phones associated with the unanswered calls and further third mobile phones associated with the personal chat group.

4. The method of claim 3 further comprising the steps of:
storing the first SMS messages at a telecommunications network; and
automatically sending the first SMS message from the telecommunications network when the first mobile phone is powered up;
wherein the mobile phone is operatively connected to the telecommunications network.

5. The method of claim 3 further comprising the steps of:
storing the second SMS messages at a telecommunications network; and
automatically sending the second SMS messages from the telecommunications network when the first mobile phone is powered up.

6. The method of claim 1 wherein the method further comprises in the step of creating; creating, from the first mobile phone, at least one future SMS message to be stored in the telecommunications network and sent at a future time to at least one second mobile phone.

7. The method of claim 6 wherein the at least one call time is a predetermined future time, and wherein the at least one future SMS message is stored at the telecommunications network.

8. A method for automatically notifying at least one of unanswered callers and a personal chat group that a mobile phone is ready to accept calls, said method comprising the steps of:
creating, for a first mobile phone, at least one of a first SMS message to be sent for unanswered calls, the unanswered calls occurring when the first mobile phone is powered down, and a second SMS message to be sent to a personal chat group; and
automatically sending, when the first mobile phone is powered up, the created SMS messages to at least one of further second mobile phones associated with the unanswered calls and further third mobile phones associated with the personal chat group.

9. The method of claim 8 further comprising the steps of:
storing the first SMS messages at a telecommunications network; and
automatically sending the first SMS messages from the telecommunications network when the first mobile phone is powered up;
wherein the mobile phone is operatively connected to the telecommunications network.

10. The method of claim 8 further comprising the steps of:
storing the second SMS messages at the telecommunications network; and
automatically sending the second SMS messages from the telecommunications network when the first mobile phone is powered up.

11. A method for notification, said method comprising the steps of:
creating, for a first mobile phone, at least one future SMS message to be stored at the telecommunications network and sent at a future time to at least one second mobile phone; and
sending, when the future time occurs, the stored at least one future SMS message to the at least one second mobile phone.

12. The method of claim 11 further comprising the step of storing at the first mobile phone the at least one future SMS message and an identification of the at least one second mobile phone.

13. A system for automatically notifying at least one of unanswered callers and a personal chat group that a mobile phone is ready to accept calls, said system comprising:
a message creation module in a first mobile phone;
at least one of a first SMS message to be sent for unanswered calls, the unanswered calls occurring when the first mobile phone is powered down, and a second SMS message to be sent to a personal chat group, the first and second messages being created by the message creation module in the first mobile phone and stored in the telecommunications network; and
at least one transmission module for effecting automatic sending, when the first mobile phone is powered up, the stored SMS messages to at least one of further second mobile phones associated with the unanswered calls and further third mobile phones associated with the personal chat group.

14. The system of claim 13 further comprising:
a storage in a telecommunications network in which is stored the at least one first SMS message; and
wherein the mobile phone is operatively connected to the telecommunications network.

15. The system of claim 13 further comprising:
a storage in a telecommunications network in which is stored the at least one second SMS message.

16. A system for notification, said system comprising:
a message creation module in a first mobile phone;
at least one future SMS message to be sent at a future time to at least one second mobile phone, the at least one future SMS message being created in the message creation module in a first mobile phone and stored in the telecommunications network; and
a transmission module in the telecommunications network for effecting automatic sending, when the future time occurs, of the created at least one future SMS message to the at least one second mobile phone.

17. The system of claim 16 further comprising a storage in the telecommunications network in which is stored the at least one future SMS message and an identification of the at least one second mobile phone.
